(19) United States
(12) Patent Application Publication
(10) Pub. No.: US 2008/0021155 A1
(43) Pub. Date: Jan. 24, 2008

(54) Methods for Producing Modified Aromatic Renewable Materials and Compositions Thereof

(76) Inventors: Pierre J. Bono, Le Cannet (FR); Adil Barakat, Lausanne (CH); Stephane Lepifre, Lausanne (CH); Jairo H. Lora, Media, PA (US)

Correspondence Address: Licata & Tyrrell P.C., 66 E. Main Street, Marlton, NJ, 08053, US

(21) Appl. No.: 11/737,884

(22) Filed: Apr. 20, 2007

Related U.S. Application Data
(60) Provisional application No. 60/817,128, filed on Jun. 28, 2006.
(60) Provisional application No. 60/794,267, filed on Apr. 21, 2006.

(51) Int. Cl. C07G 1/00; C08G 8/34

(52) U.S. Cl. 525/54.42; 530/504; 530/507

(57) ABSTRACT

Methods for producing modified renewable aromatic materials with lower softening temperatures and/or enhanced reactivity and compositions containing these modified aromatic products are provided.

This patent application claims the benefit of priority from U.S. Provisional Application Ser. No. 60/817,128, filed Jun. 28, 2006 and U.S. Provisional Application Ser. No. 60/794,267, filed Apr. 21, 2006, teachings of each of which are herein incorporated by reference in their entirety.

### FIELD OF THE INVENTION

This present invention relates to a process for the production of modified aromatic renewable materials with lower softening temperatures and/or enhanced reactivities, for use particularly in thermoset systems. The process of the present invention is a chemo-thermo-mechanical (CTM) process that includes the addition of additives under heat, pressure, and mechanical shear. The additives preferably exert a plasticizing effect on the aromatic renewable material and introduce flexible chains in the molecules of aromatic renewable material and/or increase reactivity of the aromatic renewable material. Modified aromatic renewable materials obtained from the process of the present invention can be incorporated in greater amounts as compared to unmodified materials, such as lignin obtained from well known processes in thermoset products and with better retention of their properties.

### BACKGROUND OF THE INVENTION

Wood and other vegetable biomass including, but not limited to wheat straw, grasses and flax are primarily composed of carbohydrates (cellulose and hemicellulose) and an aromatic polyphenolic compound called lignin. Lignin is the second most abundant renewable polymer, playing a vital role in nature, by binding the cellulose fibers together, and providing the tree or other lignocellulosic biomass with structural strength, stiffness, and moisture resistance, among other characteristics. The production of pulp for paper and other applications normally involves the dissolution and removal of the lignin from wood and other lignocellulosic biomasses. Every year tens of millions of tons of lignin are dissolved by the kraft, sulfite or soda pulping processes as part of the production of cellulose pulp for paper or other uses. Over 97% of such lignin is either burned for energy or is released into the environment causing significant pollution. Less than 3% of it is used industrially mostly as a dispersant in concrete, dyes, agricultural chemicals and other applications.

Other naturally occurring aromatic chemicals of industrial significance include among others: tannins (present mainly in the barks of trees such as mangrove, chestnut and quebracho)and cardanol and related compounds, present in cashew nut shell extracts,

Phenol formaldehyde (PF) resins are traditionally obtained by the acid or base catalyzed copolymerization of phenol and formaldehyde in liquid phase in a kettle or reaction vessel under a wide range of conditions depending on end-user application. PF resins are used in many industrial applications including, but not limited to, as binders for wood adhesives, foundry sands, molding compounds, friction materials, and abrasives. Usually the PF resin is used under heat and pressure (sometimes in the presence of a crosslinker and a catalyst) which causes it to flow and undergo irreversible crosslinking, i.e., thermosetting. PF resins normally exhibit a high resistance to water and are used in durable applications such as in the manufacture of exterior grade wood panels.

Phenol and formaldehyde are derived from non-renewable resources such as coal and oil. Since mankind is faced with decreasing reserves of such fossil materials it is highly desirable that alternate renewable sources of PF resins become industrially available.

Because of its phenolic chemical structure lignin and other naturally occurring aromatic chemicals appear to be ideally suited for incorporation in phenol formaldehyde resins. Unfortunately, they have various shortcomings. For instance, when lignin is extracted during conventional pulp and paper making processes (kraft, sulfite or soda) it is obtained in a form with limited potential for use in PF resin systems. It does not flow sufficiently and does not react sufficiently and at a rapid rate to form a bond of sufficient strength to produce products of the required strength and water resistance. The reasons for such shortcomings have to do with several factors, including steric hindrance, the rigidity of the molecule and its high viscosity, and the lack of sufficient number of available reactive sites.

Other thermoset systems that may benefit from the introduction of renewable aromatic materials include, but are not limited to epoxy systems and urethane systems.

### SUMMARY OF THE INVENTION

An object of the present invention is to provide a method for the production of modified aromatic renewable materials with low softening temperatures and increased reactivity in thermoset systems using reactive processing.

In one embodiment, the method comprises subjecting an aromatic renewable material to a chemo-thermo-mechanical (CTM) treatment under mechanical shear at a maximum temperature of about 100 to about 220° C., a pressure ranging between about 0.5 to about 10 atmospheres in the presence of an additive which lowers the softening point of the aromatic renewable material.

In another embodiment, the method comprises subjecting an aromatic renewable material to a chemo-thermo-mechanical (CTM) treatment under mechanical shear at a maximum temperature of about 100 to about 220° C., a pressure ranging between about 0.5 to about 10 atmospheres in the presence of an additive which enhances reactivity of the aromatic renewable material.

In yet another embodiment, the method comprises subjecting an aromatic renewable material to a chemo-thermo-mechanical (CTM) treatment under mechanical shear at a maximum temperature of about 100 to about 220° C., a pressure ranging between about 0.5 to about 10 atmospheres in the presence of an additive which enhances reactivity of the aromatic renewable material and in the presence of an additive which lowers the softening point of the renewable aromatic material.

Another object of the present invention is to provide compositions comprising modified aromatic renewable materials with a lower softening point and/or enhanced reactivity produced in accordance with the processes described herein. Such compositions are useful in production of, for example, binders for wood adhesives, foundry sands, molding compounds, friction materials, and abrasives, among others.

The modification procedures described herein are applicable to aromatic renewable products such as lignin as well as tannins and cardanol, and combinations thereof. Further, in addition to un-modified aromatic renewable materials, other aromatic renewable materials that may have been already chemically modified such as by methylolation (reaction with formaldehyde), phenolation, epoxidation, hydroxypropylation may be improved by the present invention.

The modification procedures described herein can be practiced simultaneously by blending all components at the beginning of the process or in multi-step sequence in which a treatment with one additive or group of additives under one set of conditions is followed by treatments with other additives under the same or different set of conditions.

### BRIEF DESCRIPTION OF THE FIGURES

FIGS. 1-5 provide diagrams of an exemplary apparatus for processing a modified aromatic renewable material in accordance with various embodiments of methods of the present invention.

FIG. 1 depicts an embodiment wherein the renewable aromatic material is fed from a hopper to the extruder through the main feeder. Diethylene glycol (DEG) is directly added to the extruder via a pump. Accordingly, in this embodiment, the extruder must be capable of blending DEG and the renewable aromatic material efficiently and of raising the temperature while applying shear so that the renewable aromatic material is softened. In addition to conveying the blended DEG and renewable aromatic material to the cooling conveyor, the extruder also preferably is capable of adding shear via its geometry and the geometry of the extruder screws and by rotation of the extruder screws.

FIG. 2 depicts an embodiment wherein the renewable aromatic material and hexamethylenetetramine (hexa) are fed from separate hoppers into the main feeder and onto the extruder to increase the reactivity of the renewable aromatic material.

FIG. 3 depicts an embodiment wherein the renewable aromatic material and hexamethylenetetramine (hexa) are fed from separate hoppers into the main feeder and onto the extruder; after allowing certain residence time for modification of the renewable aromatic material with hexa, DEG is directly added to the extruder via a pump. Thus, in this embodiment the renewable aromatic material is treated with hexa to increase reactivity first, and then treated with DEG to reduce the softening temperature.

FIG. 4 depicts an embodiment wherein the renewable aromatic material is treated simultaneously with hexa and DEG to increase reactivity and reduce the softening point of the renewable aromatic material. In this embodiment, the renewable aromatic material and hexa are added together using the main feeder and then DEG is pumped into the extruder before any significant amount of CTM treatment has been done on the renewable aromatic material-hexa blend. In this embodiment, the extruder must have suitable mixing elements in the zone where the materials are fed.

FIG. 5 depicts an embodiment wherein renewable aromatic material fed from the main feeder on to the extruder is treated with DEG first and then with hexa to obtain a modified renewable aromatic material with enhanced reactivity and lower softening temperature.

### DETAILED DESCRIPTION OF THE INVENTION

The present invention provides methods for the production of modified aromatic renewable materials with lower softening temperatures and/or increased reactivity in thermoset systems using reactive processing. The modification procedures described herein are applicable to aromatic renewable products such as lignin as well as tannins and cardanol, and combinations thereof. Further, in addition to un-modified aromatic renewable materials, other aromatic renewable materials that may have been already chemically modified such as by methylolation (reaction with formaldehyde), phenolation, epoxidation, hydroxypropylation may be improved by the present invention.

Modified renewable aromatic materials with lower softening temperature exhibit higher flow under heat relative to unmodified renewable aromatic materials and have the capability to react better with components present in PF resin formulations, such as novolac resins, low molecular weight phenolic materials, and crosslinkers such as formaldehyde and formaldehyde donors.

To produce modified renewable aromatic materials with lower softening temperature, the renewable aromatic material is first subjected to a chemo-thermo-mechanical (CTM) treatment at a maximum temperature of about 100 to about 220° C., a pressure ranging between about 0.5 to about 10 atmospheres and under a mechanical shear created, for example, by rotation in an extruder wherein processing occurs in the presence of a relatively small amount (0.5 to 20 parts per hundred (phr)) of an additive. The CTM treatment is highly effective occurring at high concentration and with very fast kinetics. The lowering of the softening point is believed to be a result of a combination of one or more factors, namely, the plasticizing effect of the additive; the solvating effect of the additive; chemical modification of the lignin by depolymerization under high temperature and in the presence of catalytic amounts of acidity; and/or reaction of the additive with the renewable aromatic material to introduce flexible (soft) segments in the rigid molecules of the renewable aromatic material. Thus, to produce modified renewable aromatic materials with a lower softening temperature, the additive preferably has a plasticizing effect on the renewable aromatic material, is a reasonably good solvent for the renewable aromatic material and also has the potential to react with the renewable aromatic material. Examples of additives for producing modified renewable aromatic materials with a lower softening temperature include, but are not limited to glycols, such as diethylene glycol (DEG), triethylene glycol, and polyethylene glycol of various molecular weights, preferably low molecular weight polyethylene glycols.

Processing of the present invention is applicable to any source of renewable aromatic material. For example, for lignin, sources include but are not limited to, lignin from softwoods, hardwoods and non-woods such as straw or flax, obtained by any pulping or delignification process including, but not limited to, kraft, soda, soda-AQ, soda-oxygen, sulfite, and organosolv, as well as from processes used in, for example, a biorefinery to pre-treat a vegetable biomass to produce ethanol and/or other products from any type of vegetable biomass, or in processes to produce dietary fiber.

The significance of the CTM treatment in the process of the present invention to modification of the exemplary renewable aromatic material lignin was demonstrated in comparative experiments wherein blends of lignin and additive were heated in an oven without shear or pressure. In these experiments, lignin and DEG were heated in an oven for various amounts of time ranging from less than a minute to 1 hour at temperatures between 160 and 210° C. No significant reduction in softening temperature was observed in these lignin samples. Instead, the lignin samples behaved similarly to untreated lignin. Thus, these experiments confirm the importance of intimate mechanical action in the process of the present invention to obtain the desired softening temperature reduction in the modified lignins.

Modified lignin with enhanced reactivity is produced similarly by treatment of lignin at a maximum temperature of about 100 to about 220° C., a pressure ranging between about 0.5 to about 10 atmospheres and under a mechanical shear created, for example, by rotation in an extruder in the presence of a compound that reacts with the lignin by introducing chemical groups with increased reactivity. The modified lignin produced in accordance with this method exhibits enhanced reactivity by virtue of higher flow, lower viscosity, and increased molecular mobility.

An exemplary group of compounds that when reacted with a renewable aromatic material under heat and pressure results in introduction of highly reactive groups includes, but is not limited to formaldehyde donors such as hexamethylenetetramine (hexa), paraformaldehyde, and glyoxal. It is believed that the treatment with this class of compounds results in modified renewable aromatic materials with enhanced reactivity by virtue of the introduction of more reactive sites. For example, upon treatment with hexa, methylol and/or oxazol groups are expected to be introduced in the lignin molecule. Another exemplary group of compounds that enhances reactivity when present during the CTM treatment of a renewable aromatic material are selected phenolic compounds such as, but not limited to, para-tert-butyl phenol bis-phenol A, naphthols, cresols, xylenols, and low molecular weight phenolic resins, among others. In addition, furan compounds, such as, but not limited to, furfuryl alcohol, furfural, and other furan derivatives including but not limited to oligomers, pre-polymers and low molecular weight polymers obtained from the polymerization of furfuryl alcohol and related compounds can be added during CTM treatment to enhance reactivity of the renewable aromatic material. The treatment with furfuryl alcohol, for example, results in the introduction of a reactive furan ring and reactive methylol groups to the lignin molecule. In addition, furfuryl alcohol, furfural and other furan derivatives have solvating and plasticizing effects on renewable aromatic materials such as lignin. This class of additives therefore simultaneously improves reactivity and reduces softening temperature.

Following the CTM treatment the resulting modified renewable aromatic material is rapidly cooled to below 60° C., preferably below 40° C. to stabilize the modified renewable aromatic material and quench any reactions that may be taking place. Once cooled, the modified renewable aromatic material is preferably ground, screened and packed. An additional advantage of modified renewable aromatic materials such as modified lignin produced in accordance with the process of the present invention is that some of the modified lignin products have an increased bulk packing density without significant change in particle size. The increase in density results in great economies in transportation cost.

The processes for modifying renewable aromatic materials to lower their softening point and/or increase reactivity can be performed separately or combined to obtain products with a wide range of modified characteristics. For example, lignin that has been CTM treated to increase reactivity may be CTM treated to reduce softening temperature. The opposite can also be performed, depending on the desired product characteristics for the modified lignin. In some embodiments, it may be desirable to perform CTM treatment of lignin for softening point reduction first, followed by CTM treatment with compounds that enhance the lignins reactivity. Furthermore, it is possible to treat lignin simultaneously with more than one additive, for instance DEG and hexa can be used simultaneously to reduce softening temperature and increasing reactivity at the same time.

Modified renewable aromatic materials, particularly modified lignin with enhanced reactivity produced in accordance with the present invention, is especially useful as a replacement of phenol in the synthesis of phenolic resins including, but not limited to, phenolic resin uses such as wood adhesives, insulation, friction materials, molding compounds, foundry binders, and abrasives, among others. For example, lignin reacted with hexa can be used to a greater extent and with shorter reaction time.

Modified lignin with lower softening point produced in accordance with the present invention is preferred for those applications that use powder phenolic resins, for instance, molding compounds, friction materials, and certain wood adhesives such as those used for oriented strand board. In this embodiment the modified lignin is used as a partial replacement of the resin itself, not of the phenol used to synthesize the resin. Modified lignin with low softening point can also be used in products such as wood polymer composites or as a binder in the manufacture of molded products, for instance those made by injection molding of fibers and binders. Furthermore, modified lignin with lower softening point may be used as a partial replacement of phenol in the synthesis of phenolic resins.

Various pieces of equipment can be used to carry out the processes of the present invention. In one embodiment, the CTM treatment is performed in a batch reactor such as in a Haake Rheomix 600 Polylab mixer made by Thermo Electron Corporation (81 Wyman Street, Waltham, Mass. 02454, USA) or in a Banbury Mixer (Farrel Corporation, 25 Main Street, Ansonia, Conn. 06401, USA)

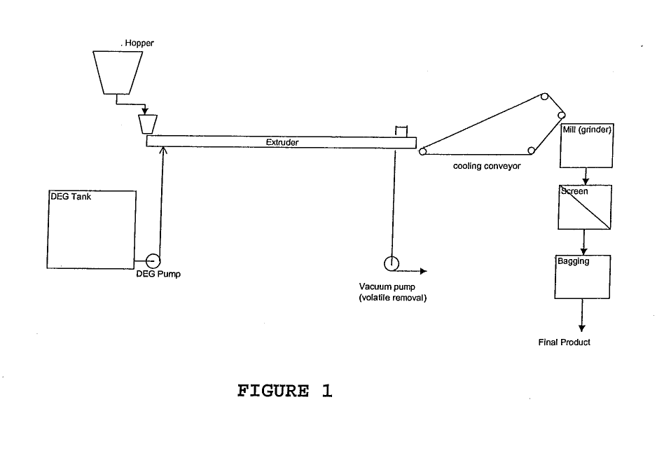

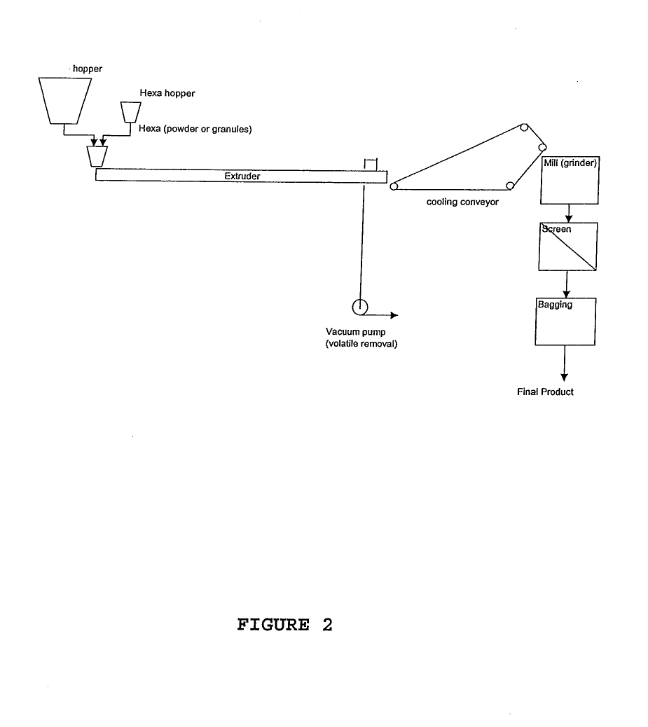

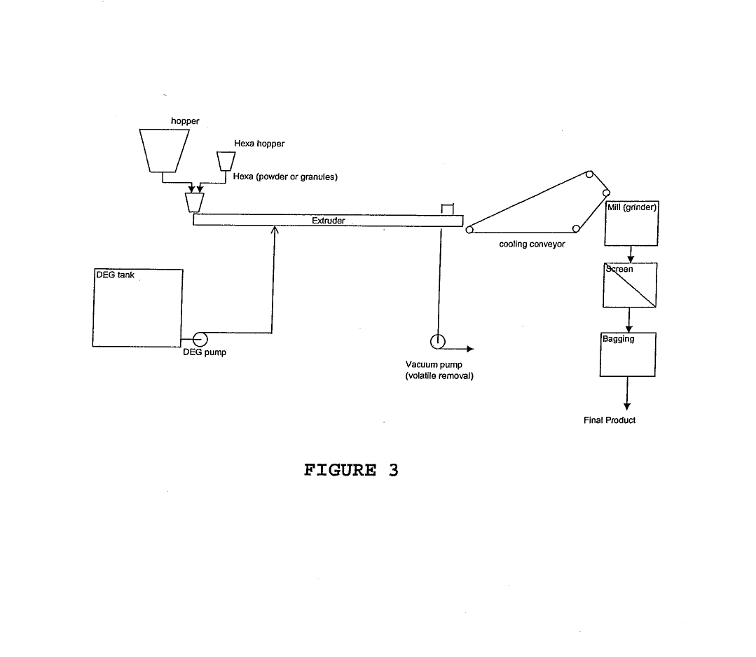

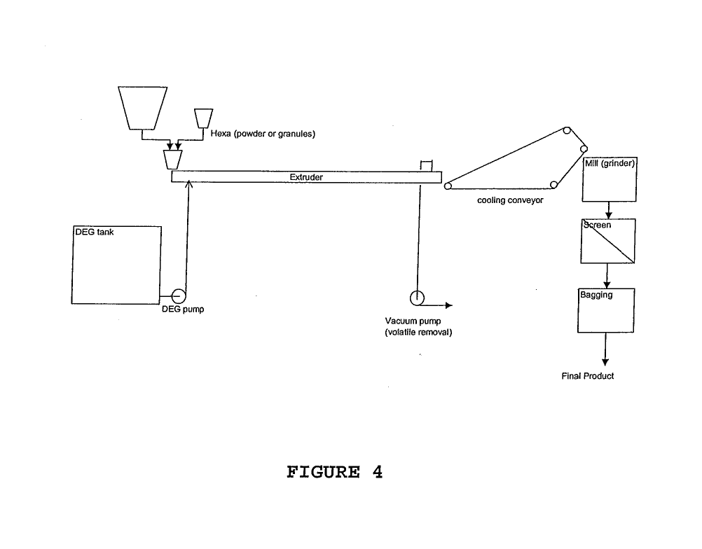

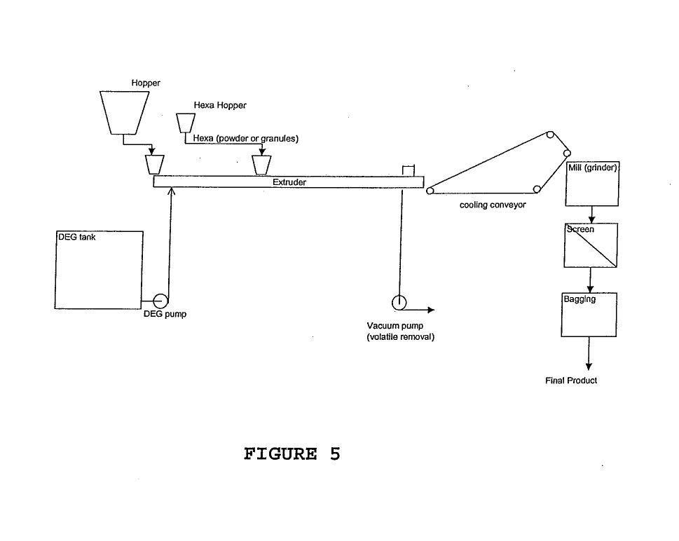

In another embodiment, as depicted in FIGS. 1 through 5, the process is performed continuously in an extruder. Double screw extruders are particularly useful for the process of the present invention as they provide a means to continuously carry out the process of the invention, accurately regulating temperatures in the various zones of the extruder, and providing for addition of the additive in specific zones and having the capability to modify the shear and residence time according to the desired results. However, single screw extruders are also effective, permitting similar flexibility in operating conditions. Either extruder can also be easily integrated with equipment to cool down the modified renewable aromatic material product processed in the extruder at a fast rate.

As shown in FIGS. 1 through 5, the renewable aromatic material can be blended with one or more additives during the CTM treatment on the extruder or in the batch reactor. In this embodiment, the extruder, batch reactor or other processing means must have blending capabilities. Alternatively, the renewable aromatic material may be pre-blended with one or more additives prior to CTM treatment.

The lower softening point and higher reactivity modified renewable aromatic materials such as modified lignins of the present invention can be used as replacement for PF resins to a greater extent and with more reliability than unmodified lignins. Application areas where these products can be used to maximum advantage are those applications in which powder PF resins are used. Examples include, but are not limited to, friction materials (such as brake pads), molding compounds, tackifying resins, abrasives, and wood panels (such as oriented strand board) among others. Lignins modified to have higher reactivity can be used as substitutes for phenol in the manufacture of phenolic resins by conventional procedures, i.e., in a kettle or reaction vessel in the presence of acid or alkaline catalysts, as required by the end use of the resin. Accordingly, modified lignins of the present invention provide a means for replacing higher quantities of phenol and formaldehyde in the manufacture of PF resins for any of the applications in which PF resins are used.

The modification procedures described herein can also be applied to other aromatic renewable products and combinations thereof. For instance the processes can be applied to tannins or cardanol, or to combinations of lignin and/or tannin and/or cardanol.

In addition to un-modified aromatic renewable materials, other aromatic renewable materials that may have been already chemically modified such as by methylolation (reaction with formaldehyde), phenolation, epoxidation, hydroxypropylation may be improved by the invention.

The following nonlimiting examples are provided to further illustrate the present invention.

### EXAMPLES

### Example 1

### Origin of the Lignins and Other Chemicals Used

Soda lignin cake at about 35% solids was obtained from Asian Lignin Manufacturing Pvt. Ltd. (Chandigarh, Punjab, INDIA), a company which recovers lignin from several raw materials including wheat straw and sarkanda grass alone or in combination, among others. The lignin cakes were dried in a continuous dryer, in some cases after adjusting the pH of the cake.

Samples with the following characteristics were obtained:

| | Sample | | | |
|---|---|---|---|---|
| | Sample designation | | | |
| | SA (100 SA | | WA (100 WA | |
| Property | 140-2) | SN | 140-1) | WN |
| Type of | Sarkanda | Sarkanda | Wheat | Wheat |
| lignin | Low pH | Near | Straw Low | Straw Near |
| | | neutral | pH | neutral |
| % solids | 93.59 | 94.83 | 96.38 | 95.0 |
| Softening | >200 | >200 | >200 | >200 |
| temperature, | | | | |
| C. | | | | |
| pH | 2.11 | 5.97 | 2.27 | 6.07 |
| % ash | 2.61 | 8.04 | 2.71 | 6.66 |
| Aromatic OH, | 1.75 | 2.33 | 1.90 | 1.85 |
| mmole/g | | | | |
| Carboxyl, | 2.12 | 1.59 | 2.28 | 2.17 |
| mmole/g | | | | |

In addition lignin was obtained from Asian Lignin Manufacturing Pvt Ltd in powder form, having the characteristics mentioned below:

| Sample designation | WSA |
|---|---|
| Type of lignin | Mixture Sarkanda and Wheat Straw - |
| | Soda process |
| % solids | >96% |
| Softening temperature, C. | >200° C. |
| pH | 4-5 |

Additives diethylene glycol (DEG), triethyleneglycol (TEG), polyethylene glycol (PEG), and hexamethylenetetramine (HEXA) were purchased from chemicals suppliers.

### Example 2

### Effect of Treatment with DEG of Various Lignin Materials in Rheomix 600 Trials

A pre-blend of each lignin sample was made with DEG at a level of 10 parts per hundred (PHR). The blends were processed for 3.5 minutes at 140° C. at 40 RPM in a Rheomix 600 made by Haake. In this apparatus the material is mixed intimately under shear and temperature. Softening point of the resulting product was determined with a melting point apparatus. The effect of the different treatments on the softening point is shown in the following table. As observed, the treatment with DEG resulted in a significant lowering of the softening point from over 200° C. for the untreated materials to 130 to 148° C. for the modified lignin.

| | | Softening | Sample |
|---|---|---|---|
| Lignin | Additive | Point, ° C. | Number |
| SA | Untreated | >200 | |
| SA | 10 PHR DEG | 130 | U 2-13 |
| WA | Untreated | >200 | |
| WA | 10 PHR DEG | 148 | U 4-12 |
| WN | Untreated | >200 | |
| WN | 10 PHR DEG | 138 | U 4-9 |

### Example 3

### Effect of Various Additives in Lowering of Softening Temperature in Rheomix 600 Trials

A pre-blend of each lignin sample was made with additives DEG, TEG and PEG. The additives were added at a level of 10 PHR. The blends were processed for 3.5 minutes at 150° C. at 40 RPM in a Rheomix 600 made by Haake. In this apparatus the material is mixed intimately under shear and temperature. The effects of the different treatments on the softening point are shown in the following table. As observed, the treatment with these glycols results in a significant lowering of the softening point from over 200° C. for the untreated materials to 117-140° C. for the modified materials.

| | | Softening | Sample |
|---|---|---|---|
| Lignin | Additive | Point, ° C. | Number |
| SA | Untreated | >200 | |
| SA | DEG | 117 | U 2-12 |
| SA | TEG | 137 | U 2-14 |
| SA | PEG | 130 | U 2-15 |
| SN | Untreated | >200 | |
| SN | DEG | 124 | U 2-16 |
| SN | TEG | 140 | U 2-17 |
| SN | PEG | 130 | U 2-18 |

### Example 4

### Lowering of Softening Temperature by Using Continuous Laboratory Extrusion System

Experiments were performed in a continuous 16 mm diameter APV laboratory extruder having 4 heating zones and using pre-blends of lignin and DEG (10 PHR). The pre-blend was fed at about 1.25 kg/hour and the extruder was operated at 40 RPM. The table below shows the temperature profile for each of the zones of the extruder and the resulting softening temperatures obtained.

| | Temperature | | | | Softening | Sample |
|---|---|---|---|---|---|---|
| Sample | profile, ° C. | | | | temperature, ° C. | Number |
| SA | 60 | 80 | 140 | 140 | 120 | U 3-17 |
| SN | 60 | 80 | 140 | 140 | 110 | U 3-18 |
| WA | 50 | 70 | 100 | 120 | 130 | U 4-21 |
| WN | 50 | 70 | 100 | 120 | 130 | U 4-22 |

### Example 5

### Lowering of Softening Temperature by Using Continuous Pilot Extrusion System

Experiments were performed using WSA lignin, which is a blend of sarkanda and wheat straw, in a continuous 30 mm diameter pilot extruder having 8 heating zones and using either a pre-blend of lignin and DEG (10 PHR) or direct addition of DEG by pumping at a rate equivalent to 10 PHR directly to the extruder at an intermediate port. The temperature profile in all cases was as follows:

65° C./75° C./90° C./110° C./115° C./115° C./115° C./100° C. The table below shows the other processing conditions and the resulting softening temperatures obtained.

| | Preblend, | Lignin | DEG, | Extruder | Softening | Sample |
|---|---|---|---|---|---|---|
| | kg/hr | kg/hr | kg/hr | RPM | temp., ° C. | Number |
| Lignin DEG | 14 | N.A. | | 100 | 134 | ST 2-3 |
| preblend from | | | | | | |
| main feeder | | | | | | |
| Lignin from | N.A. | 14 | 1.4 | 100 | 146 | ST 2-26 |
| main feeder | | | | | | |
| DEG injected | | | | | | |
| at | | | | | | |
| intermediate | | | | | | |
| point | | | | | | |
| Lignin from | N.A. | 35 | 3.5 | 350 | 150 | ST 2-27 |
| main feeder | | | | | | |
| DEG injected | | | | | | |
| at | | | | | | |
| intermediate | | | | | | |
| point | | | | | | |

N. A. Not applicable

### Example 6

### Evaluation of Reactivity of Modified Lignins by Differential Scanning Calorimetry

A convenient and reliable way to assess the reactivity of lignins can be done in a differential scanning calorimeter (DSC), such as DSC 20 from Mettler Toledo (Mettler-Toledo, Inc., 1900 Polaris Parkway, Columbus, Ohio, 43240). In this test, lignin was blended with a co-reactant novolac resin in a 50:50 ratio and hexa is added for cross linking. The DSC provides information on the energy released or consumed as the sample is heated a controlled rate (8° C./minute) in a nitrogen atmosphere. In all evaluations disclosed herein open DSC pans were used. In the following table un-treated lignin is compared to lignins treated with DEG as described in the preceding examples. As can be seen, lignin modified by CTM processing when blended with novolac and hexa gave 36-117% higher reactivity than blends of the untreated lignins with novolac and hexa.

| | | | | Energy | |
|---|---|---|---|---|---|
| | | | | released | % energy |
| | | | | (50/50 | increase |
| | | | | blend with | relative |
| | | | | novolac + | to |
| Original | Additive/ | Softening | Sample | 8% hexa) | untreated |
| Lignin | Process | Point, ° C. | Number | J/g | lignin |
| WA | Untreated | >200 | 100 WA 140 | 21 | |
| WA | 10 PHR | 148 | U 4-12 | 45.8 | 117 |
| | DEG/Batch | | (Example 2) | | |
| | Rheomix | | | | |
| SA | Untreated | >200 | 100 SA 140 | 27.7 | |
| SA | 10 PHR | 120 | U 3-17 | 55.8 | 101 |
| | DEG/ | | (Example 4) | | |
| | Laboratory | | | | |
| | extruder | | | | |
| WSA | Untreated | >200 | 05-0063 | 25.0 | |
| WSA | 10 PHR | 134 | ST 2-3 | 38.4 | 54 |
| | DEG/Pilot | | (Example 5) | | |
| | extruder | | | | |
| WSA | 10 PHR | 146 | ST 2-26 | 39.5 | 58 |
| | DEG/Pilot | | (Example 5) | | |
| | extruder | | | | |
| WSA | 10 PHR | 150 | ST 2-27 | 33.9 | 36 |
| | DEG/Pilot | | (Example 5) | | |
| | extruder | | | | |

### Example 7

### Changes in Functional Groups as a Result of DEG Treatment

Chemical variation due to the CTM treatment was assessed by measuring phenolic OH and carboxylic acid content by titration. The results are shown in the Table below. As can be seen, variations in the CTM processing induce minor changes in the functional groups of the lignin molecule.

| Original | Additive/ | Softening | Sample | Phenolic OH | Carboxyl |
|---|---|---|---|---|---|
| Lignin | Process | Point, ° C. | Number | mmole/g | mmole/g |
| WA | Untreated | >200 | | 1.9 (1.97) * | 2.28 (2.37) |
| WA | 10 PHR | 148 | U 4-12 | 1.68 (1.92) * | 2.06 (2.35) * |
| | DEG/Batch | | (Example 2) | | |
| | Rheomix | | | | |
| SA | Untreated | >200 | | 1.75 (1.87) * | 2.12 (2.27) * |
| SA | 10 PHR | 120 | U 3-17 | 1.61 (1.89) * | 2.08 (2.44) * |
| | DEG/ | | (Example 4) | | |
| | Laboratory | | | | |
| | extruder | | | | |
| WSA | Untreated | >200 | | 1.86 (1.89) * | 2.2 (2.24) * |
| WSA | 10 PHR | 134 | ST 2-3 | 1.60 (1.79) * | 2.15 (2.41) * |
| | DEG/Pilot | | (Example 5) | | |
| | extruder | | | | |
| WSA | 10 PHR | 146 | ST 2-26 | 1.76 (1.96) * | 2.03 (2.27) * |
| | DEG/Pilot | | (Example 5) | | |
| | extruder | | | | |
| WSA | 10 PHR | 150 | ST 2-27 | 1.73 (1.93) * | 2.15 (2.40) * |
| | DEG/Pilot | | (Example 5) | | |
| | extruder | | | | |

* Represents estimated content on additive-free, moisture-free basis

### Example 8

### Use of Lignin Treated with DEG as Partial Replacement for Novolac Resins

Phenolic novolac resins used for applications such as molding compounds, friction materials, are characterized by their softening point, flow characteristics and gel time. The products obtained are within a range of properties, but it is always desirable to have products with longer flow and gel time and lower softening point. Lignin samples (un-treated and treated as in Example 5) were blended in a 20/80 ratio with a novolac resin produced by Asian Lignin Manufacturing, Chandigarh (India). As can be seen the blend with the untreated lignin did not flow and gelled immediately, which are undesirable characteristics in a novolac. Furthermore, the blend had a softening point higher than the novolac resin by 11° C. The modified lignin product CTM treated with DEG as in Example 5 had a softening point comparable to the novolac resin, longer gel time and longer flow relative to the blends with un-treated lignin.

| | Ratio lignin | | | Gel time at |
|---|---|---|---|---|
| Lignin | product to | Flow, | Softening | 150° C., |
| product | Resin | mm | Point ° C. | sec |
| None | 0/100 | 76 | 90 | 107 |
| Protobind | 20/80 | No melt | 101 | Instant |
| 1000 | | | | gelling. |
| Lot Number | | | | |
| 05-0063 | | | | |
| ST2-3 | 20/80 | 30 | 91 | 45 |
| ST2-26 | 20/80 | 31 | 90 | 48 |
| ST2-27 | 20/80 | 28 | 90 | 40 |

The blends of modified lignin and novolac resin described in this example are within the range of properties of novolac resins commercially used.

### Example 9

### Improvement of Reactivity by Treatment with Hexa in Batch System

Lignin was treated with 5 PHR hexa in a Rheomix batch system for 1 minute at various temperatures. The resulting product did not have improved softening temperature. However, when the resulting product was blended with novolac resin in a 50:50 ratio and 3% hexa, its reactivity, as measured by DSC was increased by more than 53% relative to untreated lignin plus novolac with 8% hexa and by more than 59% relative to the untreated reference plus novolac with 3% hexa. Thus, CTM treatment is required for enhanced reactivity. Further, the amount of hexa used during the reactivity evaluation in the DSC affects the reactivity; the optimum that releases the greatest amount of energy depends on the type of lignin being evaluated. Thus, for untreated lignin or for modified lignin treated with DEG (as in example 6, above) the optimum is about 8 PHR Hexa. For lignins that have been treated with hexa as in this example, the optimum is about 3 PHR hexa.

| | | | | % energy increase | |
|---|---|---|---|---|---|
| | | | | relative to | |
| | | | | untreated control: | |
| | | | | lignin + novolac | |
| | | | | with 3 or 8% hexa | |
| | | | Energy released | Relative | Relative |
| | | | (50/50 blend | to | to |
| | Additive/ | | with novolac + | control | control |
| Sample | Temperature | Softening | 3% or 8% hexa) | with 8% | with 3% |
| No. | in Rheomix | Point, ° C. | J/g | hexa | hexa |
| SA | Untreated | >200 | 27.7 (8%) | | |
| | | | 26.6 (3%) | | |
| U 2-1 | 5 PHR Hexa/ | >200 | 43.8 (3%) | 58 | 65 |
| | 160° C. | | | | |
| U 2-2 | 5 PHR Hexa/ | >200 | 42.3 (3%) | 53 | 59 |
| | 150° C. | | | | |
| U 2-3 | 5 PHR Hexa/ | >200 | 43.8 (3%) | 58 | 65 |
| | 140° C. | | | | |
| U 2-4 | 5 PHR Hexa/ | >200 | 42.9 (3%) | 54 | 61 |
| | 130° C. | | | | |

Sample U 2-2 was chemically analyzed for aromatic OH and carboxyl content and was found to have 1.81 mmole/g aromatic OH and 2.36 mmole/g carboxyl, as produced. After correction for moisture and additive content, the aromatic OH is estimated to be 2.03 mmole/g and the carboxyl 2.65 mmole/g, which is indicative of some modification of the functionality of the product.

### Example 10

### Evaluation of Lignin Modified with Hexa in Manufacture of Plywood Resins (ST2-17)

WSA lignin, which is a blend of sarkanda and wheat straw was pre-blended with 8 PHR hexa and treated at a throughput rate of 14 kg/hour in a continuous 30 mm diameter pilot extruder having 8 heating zones. The temperature profile in this case was as follows:

65° C./130° C./130° C./125° C./120° C./120° C./110° C./110° C. The resulting product was used to manufacture plywood resin, as a 30% substitute for phenol using the following procedure:

| | Resin with | |
|---|---|---|
| | modified lignin, | Control resin, |
| Ingredients | Grams | Grams |
| Phenol (91%) | 385 | 500 |
| Treated lignin | 156 | 0 |
| (Sample ST2-17) (96%) | | |
| Caustic (100%) | 30 | 27 |
| Water | 150 | 0 |
| Formaldehyde (37%) | 700 | 820 |

The ingredients in the above table were thoroughly mixed in a resin kettle and reacted for 90 minutes at 70-73° C.

The plywood resins obtained had the following properties, which match the properties required for plywood resins normally used industrially:

| | Resin with | |
|---|---|---|
| | modified lignin | Control resin |
| Viscosity | 70 cps | 65 |
| PH | 9.82 | 9.9 |
| Water tolerance | 1:7 | 1:9 |
| Total solids | 48% | 48% |
| Gel time at 150° C. | 58 sec. | 88 sec. |

Each of these resins was blended with 6% extender (coconut shell powder) to make a glue which was used to produce 4 mm thick plywood panels using 3 plies of vellapine venner 1.6 mm thick by pressing at 145° C. for 15 minutes. The panels had the properties presented below. As can be seen the resin made with the treated lignin surpassed the properties of the control resin

| | Resin with | |
|---|---|---|
| | modified lignin | Control resin |
| Glue coverage, | 25 | 36 |
| g/ft2 | | |
| Dry shear | 154 | 138 |
| strength, kg | | |
| Shear Strength | 134 | 130 |
| after 8 hr | | |
| boiling, kg | | |

### Example 11

### Simultaneous Treatment with DEG and Hexa in Batch Rheomix System

A pre-blend of each lignin sample was made with DEG and Hexa, as shown in the table below. The blends were processed for 3.5 minutes at 130° C. or 140° C. at 40 RPM in a Haake Rheomix 600. In this apparatus the material is mixed intimately under shear and temperature. Softening point of the resulting product was determined with a melting point apparatus. Reactivity of the resulting blends was evaluated by blending with novolac on a 50:50 ratio and adding 3-4% hexa. The effect of the different treatments on the softening point and reactivity is shown in the table below. As observed the treatment resulted in lower softening point products when the DEG level was 10 PHR. When only 5 PHR DEG is used, there is no reduction in softening point. Products with higher reactivity than the untreated lignins were obtained at either 5 or 10 PHR of DEG.

| | | | | | % energy |
|---|---|---|---|---|---|
| | | | | | increase |
| | | Processing | | Energy | versus |
| Lignin type | Sample | Temperature | Softening | released | untreated |
| (Additives) | Number | ° C. | Point, ° C. | J/g | lignin |
| SA | 100 SA-140 | | >200 | 27.7 | |
| (untreated) | | | | | |
| SA | U 3-2 | 130 | 150 | N.A. | N.A. |
| (10 PHR DEG | | | | | |
| 8 PHR Hexa) | | | | | |
| SA | U 3-5 | 140 | 180 | 41.5 | 50 |
| (10 PHR DEG | | | | | |
| 8 PHR Hexa) | | | | | |
| SA | U 4-8 | 140 | >200 | 43.1 | 56 |
| (5 PHR DEG | | | | | |
| 5 PHR Hexa) | | | | | |
| SN | 100 SN-160 | | >200 | 22.8 | |
| (untreated) | | | | | |
| SN | U 3-8 | 130 | 140 | 37.3 | 64 |
| (10 PHR DEG | | | | | |
| 8 PHR Hexa) | | | | | |
| SN | U 3-11 | 140 | 125 | N.A. | N.A. |
| (10 PHR DEG | | | | | |
| 8 PHR Hexa) | | | | | |
| SN | U 4-7 | 140 | >200 | 52.0 | 128 |
| (5 PHR DEG | | | | | |
| 5 PHR Hexa) | | | | | |

N.A. Not available
* Energy released measured by blending with novolac in ratio of 50:50 and adding 3% hexa to treated lignins and 8% hexa to un-treated lignins

### Example 12

### Simultaneous Treatment with DEG and Hexa in Continuous Pilot Extruder at Relatively Low Temperatures (ST2-12)

WSA lignin, which is a blend of sarkanda and wheat straw was pre-blended with 8 PHR hexa and 10 PHR DEG and treated at a throughput rate of 14 kg/hour in a continuous 30 mm diameter pilot extruder having 8 heating zones. The temperature profile in this case was as follows:

65° C./70° C./75° C./80° C./90° C./105° C./110° C./80° C.

The resulting product has a softening point of 145° C., thus representing a significant improvement relative to untreated lignin, which had a softening temperature above 200° C. When the modified lignin was blended with novolac in a ratio of 50:50 and 3% hexa was added, 41.3 J/g were released in a DSC run at 8° C./minute under nitrogen. This represents an improvement of 65% over the energy released by un-treated lignin.

### Example 13

### Blend of Example 12 Product With Novolac

The product of Example 12 was blended with the novolac used in Example 8 in an 80:20 novolac to modified lignin ratio. The product has the characteristics shown in the table below, where it is compared with similar blends prepared with un-treated lignin. As observed, the blend with the modified lignin had higher flow and longer gel time than the blend with the un-treated lignin.

| | Ratio lignin | | | Gel time at |
|---|---|---|---|---|
| Lignin | product to | Flow, | Softening | 150° C., |
| product | Resin | mm | Point ° C. | sec |
| None | 0/100 | 76 | 90 | 107 |
| WSA | 20/80 | No melt | 101 | Instant |
| (Unmodified | | | | gelling. |
| lignin) | | | | |
| ST2-12 | 20/80 | 19 | 99 | 31 |

### Example 14

### Sequential Treatment Hexa Followed by DEG in Batch Rheomix System

A pre-blend of WN lignin with 8 PHR hexa was processed for 1 minute at 140° C. at 40 RPM in a Haake Rheomix 600. In this apparatus the material is mixed intimately under shear and temperature. The resulting product was blended with 10 PHR DEG in a blender and the resulting mix was processed at 140° C. for 3.5 minutes in the Rheomix at 40 RPM. The resulting product had a high softening point (250 ° C.). Its reactivity was evaluated by blending with novolac on a 50:50 ratio and adding 4% hexa. The exotherm obtained (35.4 J/g) represents an improvement of 77% over the exotherm obtained when the un-treated lignin was blended with novolac (50-50 ratio) and 3% hexa.

### Example 15

### Sequential Treatment Hexa Pre-Blend Followed by DEG Pre-Blend in Continuous Pilot Extruder (ST first 4.1.2 to 4.1.4)

A series of trials were conducted to show the versatility of the process of the present invention. A pre-blend of SA lignin and 5 PHR hexa was fed from the main feeder at a rate of 12 kg/hour and a pre-blend of SA lignin and 20 PHR DEG was fed from a side feeder located in zone 5 at a rate of 12 kg/hour. Different temperature profiles were examined. The table below shows processing conditions and properties of resulting modified lignin product. Reactivity was evaluated by blending with one of two novolacs in a 50-50 ratio, then adding 8% hexa and measuring the exotherm with the DSC. The reactivity was increased in all modified lignin samples; however the ALM Novolac appeared to be more compatible with the modified lignins than Bakelite novolac. Thus, a preferred embodiment for compositions of the present invention comprises novolac specially formulated for maximum compatibility with the modified lignins of the present invention.

| | | | Softening | Exotherm, J/g | |
|---|---|---|---|---|---|
| | Temperature | Extruder | Temperature | ALM | Bakelite |
| Sample | profile, ° C. | RPM | ° C. | Novolac | Novolac |
| ST1 | 65/115/115/115/ | 200 | >200 | 54.4 | N.A. |
| 4.1.2 | 120/120/120/100 | | | | |
| ST1 | 65/120/125/115/ | 150 | >200 | 64.6 | 42.3 |
| 4.1.3 | 120/120/120/100 | | | | |
| ST1 | 65/120/125/115/ | 150 | 172 | 48.5 | 33.3 |
| 4.1.4 | 110/110/110/100 | | | | |

### Example 16

### Sequential Treatment Hexa Pre-Blend Followed by DEG Injection in Continuous Pilot Extruder (ST2-19)

In this experiment, a 30 mm pilot extruder was used. A pre-blend of SA lignin and 8 PHR hexa was fed from the main feeder at a rate of 32 kg/hour. DEG was continuously pumped in zone 5 at a rate of 3.2 kg/hour. The table below shows processing conditions and properties of resulting product. Reactivity was evaluated by blending with Bakelite novolacs in a 50-50 ratio, then adding 3% hexa and measuring the exotherm with the DSC. As can be seen, the reactivity was increased.

| | | | | | % increase |
|---|---|---|---|---|---|
| | | | Softening | | versus |
| | Temperature | Extruder | Temperature | Exotherm, | unmodified |
| Sample | profile, ° C. | RPM | ° C. | J/g | lignin |
| ST2-19 | 65/120/125/115/ | 150 | >200 | 38.3 | 38 |
| | 110/110/110/100 | | | | |

### Example 17

### Performance of Products Prepared According to Examples 5 and 12 in Oriented Strand Board

The product from Example 12 and a product prepared following the procedure of Example 5, but starting with lignin WSA, a blend of sarkanda and wheat straw lignins, were evaluated as replacement for 20% of the powder phenol formaldehyde (PF) resin commercially used to make oriented strand board (OSB) from Commercial Southern pine flakes (core and face) dried to 3% moisture and screened. 3-layer panels with dimensions 24″×24″× 7/16″ were manufactured, with 60% flake for face and 40% flake for core. The target dry panel density was 0.7 g/cm³ and the target face flake alignment level was 60%, which are the conventional levels used in industry. The PF resins used were powder OSB face and core PF resin from GP Resin Inc. The resin was used at 3.5% weight on wood in the core layer and at 3% weight on wood in the face resin. Only PF resin was used in the core, while in the face layers 20% was substituted by the modified aromatic products of the present invention. OSB wax from Hexion Specialty Chemicals Inc. at 1% was used in all the formulations. Panels were manufactured by first blending the wood flakes, PF resins and modified aromatic products while wax was sprayed. A forming box was used to form the mat for achieving target alignment level at the panel surface. Formed mats were pressed at 190° C. for 3 minutes (until the core temperature reached above 150° C.). The panels were tested according to applicable ASTM and industry methods for modulus of rupture (MOR) and modulus of elasticity (MOE) under dry conditions. After soaking for 24 hours, the panels were tested again for MOR and MOE and the water absorption and thickness swell were measured. The results obtained are presented in the following two tables. As can be seen the lignin-containing panels in general had equal or better strength properties than the controls. The lignin panels had consistently better (i.e., lower) water absorption and thickness swell than the control, showing that the presence of lignin improved the expected performance of the panels under exterior conditions. The panels using aromatic modified product from example 12 in general were better than those made with the product from example 5.

| | DRY | | AFTER 24-HOUR SOAKING | |
|---|---|---|---|---|
| | MOR | MOR | MOR | MOR |
| | PARALLEL | PERPENDICULAR | PARALLEL | PERPENDICULAR |
| | (10³ PSI) | (10³ PSI) | (10⁶ PSI) | (10⁶ PSI) |
| 100% PF | 5.38 | 2.275 | 3.12 | 1.605 |
| 80% PF | | | | |
| 20% Example 5 | 5.355 | 3.645 | 5.37 | 0.92 |
| product | | | | |
| 80% PF | | | | |
| 20% Example 12 | 6.865 | 2.885 | 4.065 | 2.115 |
| product | | | | |
| | MOR | MOR | MOR | MOR |
| | PARALLEL | PERPENDICULAR | PARALLEL | PERPENDICULAR |
| | (10³ PSI) | (10³ PSI) | (10⁶ PSI) | (10⁶ PSI) |
| 100% PF | 1.082275 | 0.26973 | 0.38676 | 0.127935 |
| 80% PF | | | | |
| 20% Example 5 | 0.97377 | 0.392075 | 0.50068 | 0.07924 |
| product | | | | |
| 80% PF | | | | |
| 20% Example 12 | 1.145025 | 0.320575 | 0.46879 | 0.15838 |
| product | | | | |

| | | THICKNESS | THICKNESS |
|---|---|---|---|
| | WATER | SWELL AT | SWELL |
| | ABSORPTION, % | EDGE, % | AT CENTER, % |
| 100% PF | 36.53 | 22.37 | 14.03 |
| 80% PF | | | |
| 20% Example | 27.51 | 16.72 | 12.90 |
| 5 product | | | |
| 80% PF | | | |
| 20% Example | 25.26 | 12.5 | 11.15 |
| 12 product | | | |

### Example 18

### Improvement of Lignin Reactivity by Treatment with Hexa in Continuous System

WSA lignin, a blend of sarkanda and wheat straw lignins, was pre-blended with 8 PHR hexa and treated at a throughput rate of about 100 kg/hour in a continuous 60 mm diameter twin screw extruder having 10 zones. The temperature profile in this case was as follows:

26° C./100° C./125° C./125° C./125° C./120° C./120° C./110° C./110° C./100° C. The reactivity of the resulting product was evaluated by blending with novolak resin and hexa, placing in sealed DSC pan and following the release of energy by DSC as described in Example 6. As observed in the table below, the energy released for the blend of novolak and modified lignin was almost 2.5 times the energy released by the blend of unmodified lignin and novolak. Furthermore the modified lignin-novolak blend released more energy than novolak by itself, indicating that this blend had a higher reactivity than novolak. In addition it can be seen that when no additional hexa was added the blend of modified lignin and novolak had a relatively high reactivity, which indicates that such a modified lignin allows a reduction in the use of hexa by the end user of the product.

| | | Hexa | | Exotherm |
|---|---|---|---|---|
| | Lignin/ | added, | Exotherm, | normalized to |
| Lignin type | Novolak | % | J/g | novolak, % |
| None | 0/1000 | 8 | 57.4 | 100 |
| (Reference) | | | | |
| Unmodified | 50/50 | 8 | 34.9 | 60.8 |
| lignin | | | | |
| Lignin | 50/50 | 3 | 84.1 | 146.5 |
| modified as | | | | |
| per this | | | | |
| example | | | | |
| Lignin | 50/50 | 0 | 51 | 88.9 |
| modified as | | | | |
| per this | | | | |
| example | | | | |

### Example 19

### Preparation of Highly Reactive Blends Based Exclusively on Lignin

Methylolated lignin was prepared by reaction with formaldehyde under alkaline conditions. Thus, 60 g of caustic was dissolved in 2 L of water. 760 g of WSA lignin, a blend of sarkanda and wheat straw lignins, was added slowly and under agitation to form a uniform solution, at which point the pH was about 10.5, then 520 g of 37% formaldehyde solution was added. The solution was heated up to a target maximum temperature (80°-90° C.) in 30-45 minutes and held at maximum temperature for a given period of time (90-135 minutes), and then was cooled down and acidified to pH 2. The resulting precipitated methylolated lignin was filtered, washed with water, and dried.

The methylolated lignin was treated with 5 phr DEG to obtain methylolated lignin/DEG and was blended with lignin modified as in Example 18. The resulting blend was evaluated for reactivity in seal pans in the DSC. The reactivity of this blend in which all the aromatic materials had a lignin origin (i.e., no aromatic compound from fossil or non-renewable sources was used) was higher than the reactivity of novolak by itself, as shown in the table below.

| | | | Exotherm |
|---|---|---|---|
| | Hexa | Exotherm, | normalized to |
| Lignin type | added, % | J/g | novolak, % |
| Novolak | 8 | 57.4 | 100 |
| 50 parts Lignin | 8 | 63.5 | 110 |
| modified as per | | | |
| example X + | | | |
| 50 parts | | | |
| Methylolated | | | |
| lignin/DEG | | | |

### Example 20

### Preparation of Highly Reactive Blends Based on Lignin and Furfuryl Alcohol

Modified lignin was prepared in a 40 mm double screw extruder by using a pre-blend of WSA lignin and 10 phr DEG. The temperature in the various extruder zones were as follows: 28° C./40° C./68° C./97° C./95° C./109° C./101° C./99° C./95° C./90° C. /95° C. The resulting modified lignin had a softening point by hot plate of 145-150° C., a melting point by capillary of 128° C. and a water content by Karl Fischer of 1.6%. This modified lignin was further modified by blending under heat and agitation with 10 phr furfuryl alcohol, a chemical compound that has good solvating properties for lignin and that is also reactive with lignin. The resulting product had a softening point by hot plate of 95° C., a melting point by capillary of 78° C. and a water content by Karl Fischer of 2.3%. As observed the further modification reduced the softening and melting point by an additional 50° C. When this lignin was evaluated for reactivity in the DSC in combination with an equal weight of novolak and in the presence of 8% hexa the energy released was 55.3 J/g which is comparable to the energy released by novolak+8% hexa (57.4 J/g).

What is claimed is:

1. A method for the production of a modified renewable aromatic material with lower softening temperature or increased reactivity in a thermoset system comprising subjecting a renewable aromatic material to a chemo-thermo-mechanical (CTM) treatment under mechanical shear, at a maximum temperature of about 100-220° C. and a pressure of about 0.5-10 atmospheres in the presence of an additive which lowers the softening point of the renewable aromatic material or an additive that enhances reactivity of the renewable aromatic material to produce a modified renewable aromatic material with lower softening temperature or increased reactivity.

2. The method of claim 1 wherein the modified renewable aromatic material has a lower softening temperature and the additive has a plasticizing effect on the renewable aromatic material, is a reasonably good solvent for the renewable aromatic material and has the potential to react with the renewable aromatic material.

3. The method of claim 2 wherein the additive comprises a glycol.

4. The method of claim 3 wherein the glycol is selected from the group consisting of diethylene glycol (DEG), triethylene glycol, and polyethylene glycol.

5. The method of claim 2 wherein the modified renewable aromatic material with a lower softening temperature exhibits enhanced reactivity.

6. The method of claim 1 wherein the modified renewable aromatic material has enhanced reactivity and the additive is selected from the group consisting of a formaldehyde donor, a phenolic compound, a furfuryl alcohol, furfural, and a furan derivative.

7. The method of claim 1 wherein the renewable aromatic material is lignin, tannin or cardanol or a combination thereof.

8. The method of claim 1 wherein the renewable aromatic material is lignin.

9. A method for the production of a modified renewable aromatic material with low softening temperature and increased reactivity in a thermoset system comprising subjecting a renewable aromatic material to a chemo-thermo-mechanical (CTM) treatment under mechanical shear, at a maximum temperature of about 100-220° C. and a pressure of about 0.5-10 atmospheres in the presence of an additive that lowers the softening point of the renewable aromatic material and an additive that enhances reactivity of the renewable aromatic material.

10. The method of claim 9 wherein the additive that lowers softening temperature has a plasticizing effect on the renewable aromatic material, is a reasonably good solvent for the renewable aromatic material and has the potential to react with the renewable aromatic material and the additive that enhances reactivity is selected from the group consisting of a formaldehyde donor, a phenolic compound, a furfuryl alcohol, furfural, and a furan derivative.

11. The method of claim 9 wherein the additive lowers softening temperature and enhances reactivity, said additive being selected from the group consisting of furfuryl alcohol, furfural and furan derivatives.

12. The method of claim 9 wherein the additive that lowers softening temperature comprises a glycol.

13. The method of claim 12 wherein the glycol is selected from the group consisting of diethylene glycol (DEG), triethylene glycol, and polyethylene glycol.

14. The method of claim 9 wherein the renewable aromatic material is lignin, tannin or cardanol or a combination thereof.

15. The method of claim 9 wherein the renewable aromatic material is lignin.

16. The method of claim 1 wherein the renewable aromatic material and one or more of the additives are pre-blended prior to the chemo-thermo-mechanical (CTM) treatment.

17. The method of claim 9 wherein the renewable aromatic material and one or more of the additives are pre-blended prior to the chemo-thermo-mechanical (CTM) treatment.

18. The method of claim 1 wherein the renewable aromatic material and one or more of the additives are blended during the chemo-thermo-mechanical (CTM) treatment.

19. The method of claim 9 wherein the renewable aromatic material and one or more of the additives are blended during the chemo-thermo-mechanical (CTM) treatment.

20. The method of claim 1 further comprising rapidly cooling the modified renewable aromatic material to stabilize the modified renewable aromatic material and quench any reactions taking place.

21. The method of claim 9 further comprising rapidly cooling the modified renewable aromatic material to stabilize the modified renewable aromatic material and quench any reactions taking place.

22. The method of claim 20 further comprising grinding, screening and packing the cooled modified renewable aromatic material.

23. The method of claim 21 further comprising grinding, screening and packing the cooled modified renewable aromatic material.

24. The method of claim 1 wherein the chemo-thermomechanical treatment is performed in a single or twin screw extruder.

25. The method of claim 9 wherein the chemo-thermomechanical treatment is performed in a single or twin screw extruder.

26. A composition comprising a modified renewable aromatic material produced in accordance with the method of claim 1.

27. The composition of claim 26 further comprising a novolac specially formulated for maximum compatibility with the modified renewable aromatic material.

28. A composition comprising a modified renewable aromatic material produced in accordance with the method of claim 9.

29. The composition of claim 28 further comprising a novolac specially formulated for maximum compatibility with the modified renewable aromatic material.

30. A phenol formaldehyde resin comprising a modified renewable aromatic material produced in accordance with the method of claim 1.

31. The phenol formaldehyde resin of claim 30 wherein the modified renewable aromatic material comprises modified lignin.

32. The phenol formaldehyde resin of claim 31 further comprising a novolac specially formulated for maximum compatibility with the modified lignin.

33. A phenol formaldehyde resin comprising a modified renewable aromatic material produced in accordance with the method of claim 9.

34. The phenol formaldehyde resin of claim 33 wherein the modified renewable aromatic material comprises modified lignin.

35. The phenol formaldehyde resin of claim 34 further comprising a novolac specially formulated for maximum compatibility with the modified lignin.
